(19) United States
(12) Patent Application Publication
(10) Pub. No.: US 2018/0252404 A1
(43) Pub. Date: Sep. 6, 2018

(54) Light Emitting Clothing

(71) Applicant: Michael Lenahan, New York, NY (US)

(72) Inventor: Michael Lenahan, New York, NY (US)

(21) Appl. No.: 15/972,123

(22) Filed: May 5, 2018

Related U.S. Application Data
(63) Continuation-in-part of application No. 29/594,289, filed on Feb. 16, 2017.
Application No. 29/594,289 is a continuation-in-part of application No. 29/623,716, filed on Oct. 26, 2017.
Application No. 29/623,716 is a continuation-in-part of application No. 29/626,310, filed on Nov. 16, 2017.

(51) Int. Cl. F21V 33/00; F21V 23/00; F21V 19/00; A41D 13/01; A63B 71/12

(52) U.S. Cl. CPC F21V 33/0008; F21V 23/003; F21V 19/0035; F21Y 2115/10; A41D 13/01; A63B 71/1216; F21V 19/005

(57) ABSTRACT

Light emitting clothing is disclosed. The light illuminating clothing has a plurality of light-emitting straps and a plurality of non-light-emitting straps. The straps are secured to metal rings to hold the straps in a desired configuration. The light-emitting straps have two light tubes disposed in parallel orientation with a space between the light tubes. LEDs are disposed at the ends of the light tubes and a control pack having batteries and a microprocessor is disposed at an end of the strap. The light emitting clothing may be in the shape of a harness to fit over top of standard clothing or may itself be embedded articles of clothing.

### PRIORITY

This application is a continuation-in-part of, and claims priority to, U.S. patent application Ser. No. 29/594,289, filed on Feb. 16, 2017, a continuation-in-part of, and claims priority to, U.S. patent application Ser. No. 29/623,716, filed on Oct. 26, 2017, and a continuation-in-part of, and claims priority to, U.S. patent application Ser. No. 29/626,310 filed on Nov. 16, 2017.

### FIELD OF THE INVENTION

The field of this invention pertains generally to light emitting clothing and more particularly to clothing having light emitting straps multiple light emitting tubes.

### BACKGROUND OF INVENTION

Clothing is known in the art. Clothing can come in any number of configurations and be used for any number of purposes. Clothing can provide warmth and safety. Certain clothing can be used for safety purposes. Clothing with reflective strips are well known. This type of clothing provides a level of safety to individuals who may be in the presence of operated motor vehicles at night. However, clothing such as these safety vests are limited. First, clothing with reflective strips requires light from an external source. This can be problematic if an approaching vehicle does not have its lights on or its lights are broken. What is needed is protective clothing with an internal light source for the purposes of fully illuminating the individual wearing the clothing.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward light illuminating clothing comprising one or more light straps and one or more rings wherein at least one end of the one or more light straps is attached to at least one of the one or more rings. The light strap comprises one or more light tubes; one or more LEDs disposed in the one or more light tubes; and a control pack containing a microprocessor unit and a battery electrically connected to the one or more LEDs.

In another embodiment the light strap comprises a first LED disposed at a first end of the light tube; a second LED disposed at a second end of the light tube; and wherein the light tube comprises a flexible polymeric tube. The light illuminating clothing may further comprise a microphone, a motion sensor, one or more snaps, and one or more buckles.

The light illuminating clothing may further comprise one or more straps, wherein each of the one or more straps has a first end and a second end, wherein at least the first end of the one or more straps is attached to at least one of the one or more rings.

The light straps may further comprise a bottom layer of material; and a middle layer of material disposed on a surface of the bottom layer of material. The light strap may further comprise two light tubes arranged in parallel orientation within two channels in the middle layer of material; and a top layer of material disposed on a surface of the middle layer of material, wherein the top layer of material is disposed in a space between the two light tubes.

The invention is also directed toward light illuminating clothing comprising a first light strap, a second light strap, and one or more rings. Each light strap has a first end and a second end and comprises a buckle disposed at the first end; one or more snaps disposed at the second end; two light tubes disposed in parallel arrangement, each light tube further comprising a LED and a flexible polymeric tube; a control pack electrically connected to the two light tubes and further comprising a microprocessor unit and a battery. The first end and second end of each light strap is attached to a ring.

The invention is also directed toward a light strap for clothing comprising a rectangular material; a control pack secured to the rectangular material; one or more light tubes disposed along at least a length of the rectangular material, the one or more light tubes electrically connected to the control pack. The light strap has a first end and a second end and the first end of the light strap is attached to a ring.

The light strap may further comprise a buckle disposed at the first end of the light strap. The light strap may further comprising one or more snaps disposed at the second end of the light strap. In another embodiment the light tube comprises a LED disposed at a first end of a hollow flexible polymeric tube. The control pack may further comprise a microprocessor unit and a battery. The light strap may further comprise a middle layer of material attached to a surface of the rectangular material; wherein the middle layer of material comprises one or more channels; wherein the one or more light tubes are respectively disposed within the one or more channels. The light strap may further comprise a top layer of material disposed on a surface of the middle layer of material. The top layer of material may be disposed in between the two light tubes.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a top perspective view of light emitting clothing;

FIG. 2 is a front plan view of light emitting clothing;

FIG. 3 is a back plan view of light emitting clothing;

FIG. 4 is a top plan view of light emitting clothing;

FIG. 5 is a back perspective view of light emitting clothing;

FIG. 6 is an enhanced back plan view of light emitting clothing;

FIG. 7 is a front plan view of lighting components;

FIG. 8 is a front plan view of lighting components;

FIG. 9 is a front plan view of lighting components;

FIG. 10 is a front plan view of electrical components;

FIG. 11 is a front plan view of electrical components; and

FIG. 12 is a top perspective view of an alternative embodiment of the invention.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

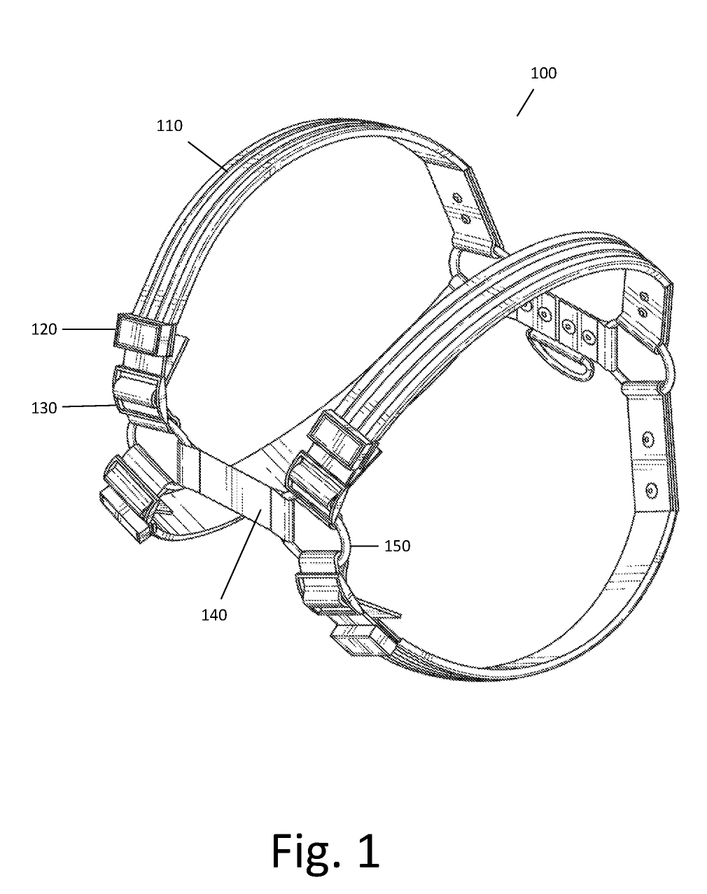

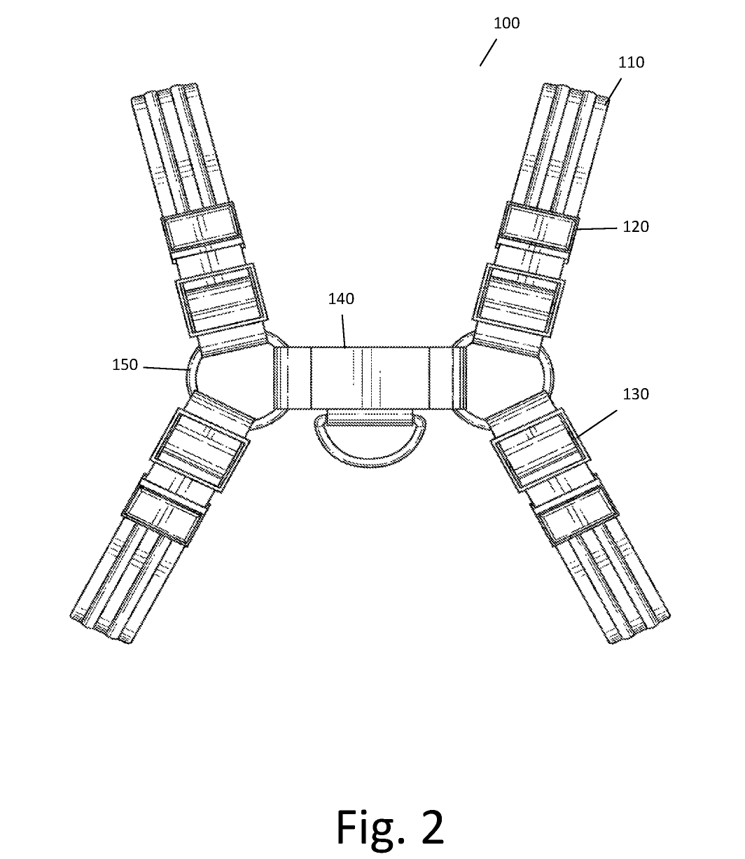

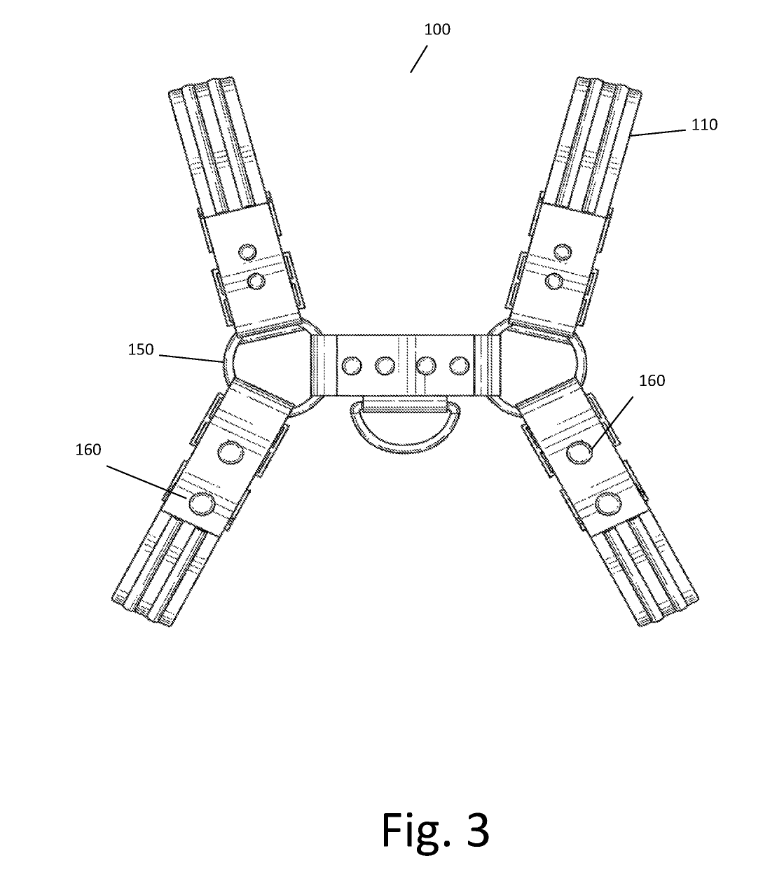

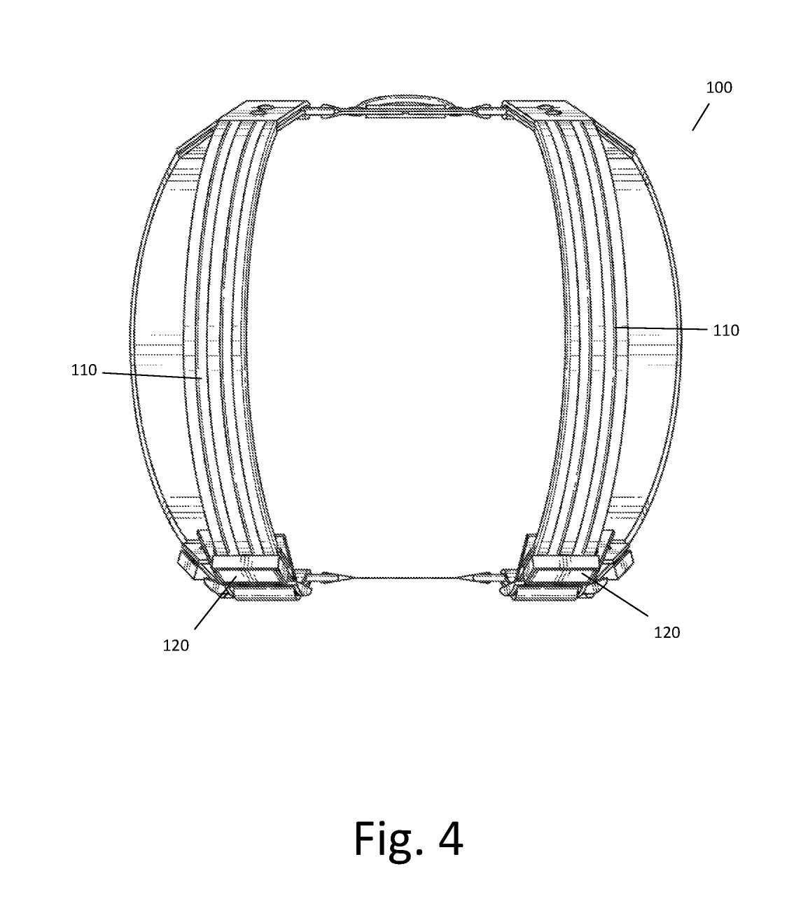

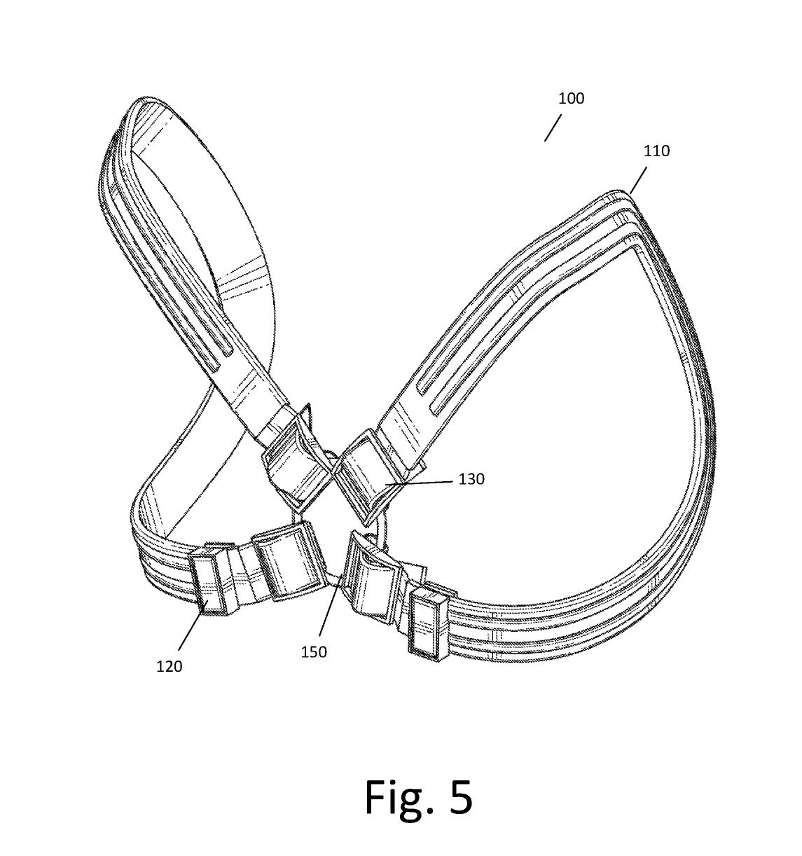

Referring to FIGS. 1-5, the preferred embodiments of the light emitting clothing 100 is illustrated. The light emitting clothing 100 can be made in any number of configurations. The light emitting clothing 100 may be made as vests, shirts, pants, underwear, socks, shoes, or any other type of clothing. In the preferred embodiment, the light emitting clothing 100 comprises one or more light straps 110, or more control packs 120, one or more buckles 130, one or more straps 140, and one or more rings 150. The light emitting clothing 100 may also have one or more snaps 160. In other embodiments, the light emitting clothing 100 may have additional fabric or leather elements connecting certain parts of one light strap 110 to another light strap 110, one light strap 110 to one strap 140, or one strap 140 to another strap 140.

The light straps 110 may be placed in any configuration. The light straps 110 may be made from any material. The light straps 110 emit light. The light emitted by the light straps 110 may be a single color or combination of multiple colors. The light emitted by the light straps 110 may be static, pulsing, or may vary with time. The light straps 110 may have portions of elastic making the light straps 110 stretchable. The light straps 110 may be any size and shape. There may be any number of light straps 110. The control packs 120 are configured to control the operation of the light straps 110 and hold the electrical components and controls required for the operation of the light straps 110. The control packs 120 may be any size and shape. The control packs 120 may be made from any material and contain any number of components. The control packs 120 may have controls and switches which change the operation of the lights on the light straps 110.

The buckles 130 may be placed in any location on the light emitting clothing 100. The buckles 130 may be connected to a light strap 110, a strap 140, or both. The buckle 130 allows the user to adjust the length of the light straps 110 and straps 140 to ensure that the light emitting clothing 100 fits properly. The buckles 130 may be any size and shape. There may be any number of buckles 130 on the light emitting clothing 100. The material of the light strap 110 or strap 140 extends around the ring 150 and reengages the buckle 130. In other embodiments the material wraps around the ring 150 and is fixed in place with one or more snaps 160. The snaps 160 may be any size and shape. In other embodiments the material is fixed in place by other means, such as hook and loop tape.

The straps 140 may be any size and shape and made from any material. There may be any number of straps 140 on the light emitting clothing 100. The straps 140 may be connected directly to the light straps 110, the buckles 130, or the rings 150. There may be any number of rings 150 on the light emitting clothing 100. The rings 150 may be made from any material but in the preferred embodiment are metal. The rings 150 may be any shape but in the preferred embodiment the rings 150 are circular. Any ring 150 may be connected to one or more light straps 110, one or more straps 140, or both.

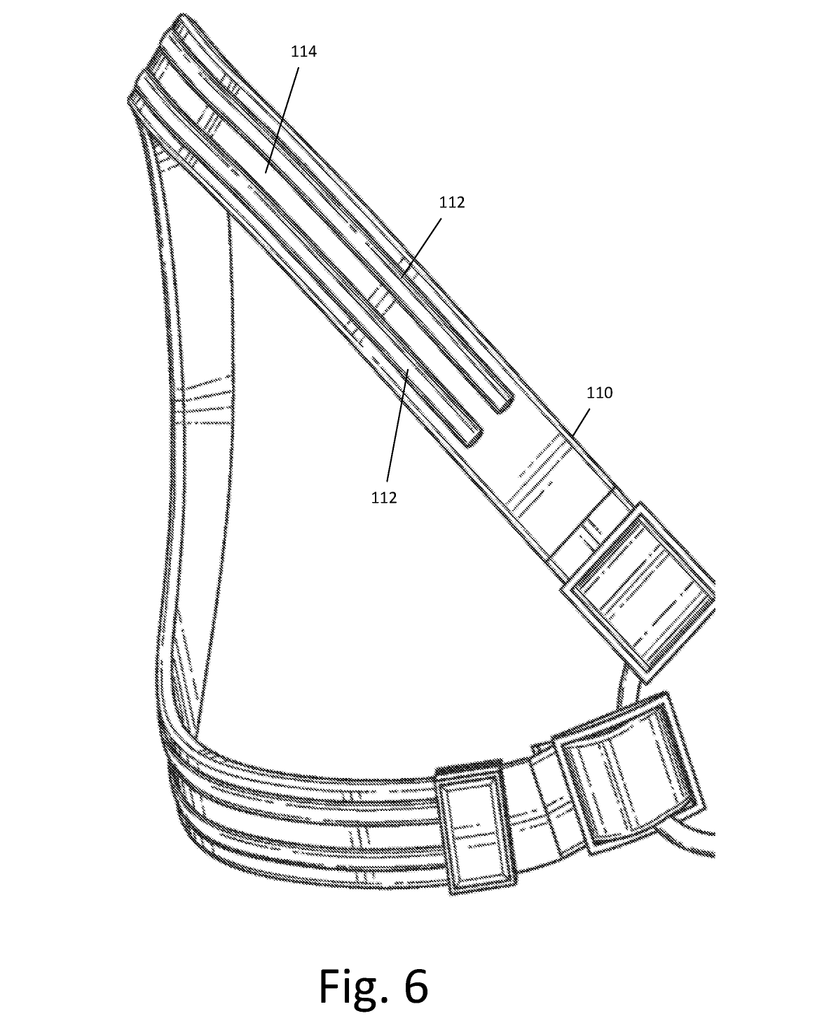

Referring to FIG. 6, an enhanced view of the light strap 110 is illustrated. The preferred embodiment of the light strap 110 is illustrated although other embodiments of the light strap 110 are possible. In the preferred embodiment of the light strap 110, the light strap 110 has two light tubes 112. In between the light tubes 112 is a space 114. In the preferred embodiment the light tubes 112 are parallel on the light strap 110. In other embodiments there may be more than two light tubes 112 with a spaces 114 in between adjacent light tubes 112. In other embodiments the light tubes 112 are in other configurations. The light tubes 112 may intersect with each other, weave back and forth, or overlap any number of times. The light tubes 112 may be any color, may be the same color, or different colors.

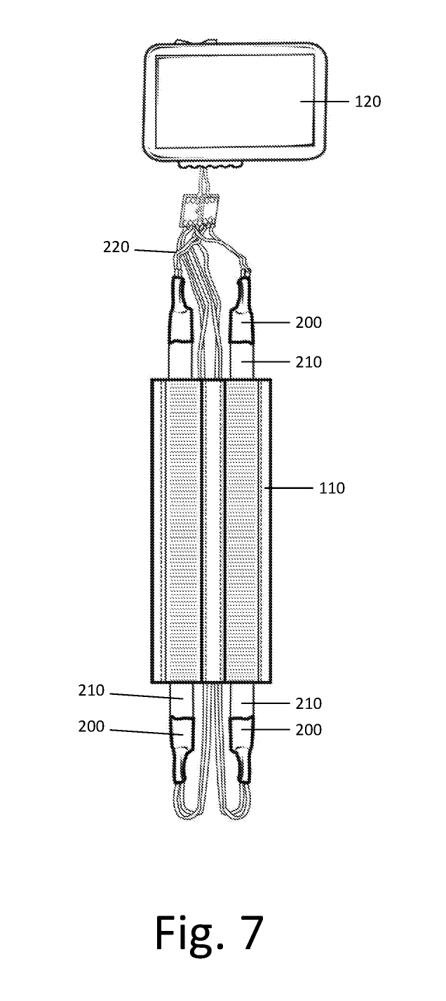

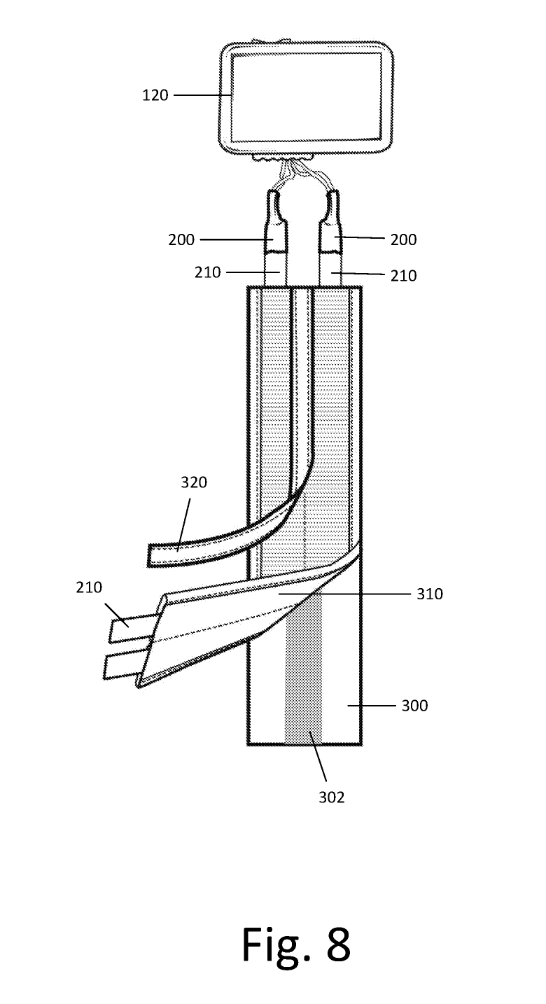

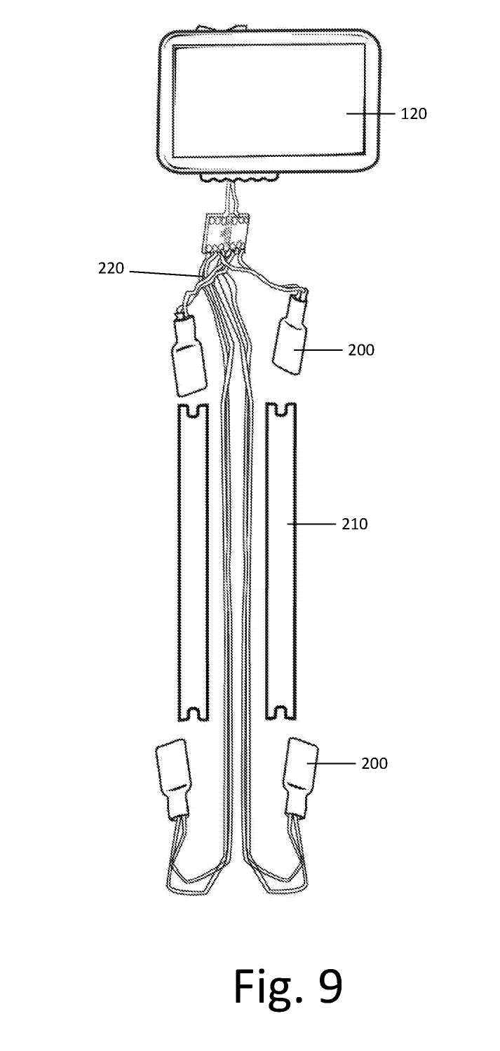

Referring to FIGS. 7-9, the construction of the light strap 110 and electric components is illustrated. The parts of the light strap 110 include the control pack 120, one or more LEDs 200, and light tubes 210 connected to the LEDs 200. As shown in FIG. 8, the wires 220 exit the control pack 120 and connect to the LEDs 200. The LEDs 200 are connected to the light tube 210. The light tube 210 may have one LED 200 connected to one end of the light tube 210 or two LEDs 200 connected to each end of the light tube. In other embodiments the LEDs 200 may be placed throughout the entire light tube 210. The light tube 210 may be any type of translucent or transparent flexible material. The light tube 210 may be solid material or may be hollow. The light tubes 210 are embedded in flexible material. The material comprises a bottom layer 300. The bottom layer 300 may be any type of material, such as cloth fabric, plastic, or leather, and may be any size and shape. The bottom layer 300 provides a substrate layer for the parts of the light strap 110. Attached on top of the bottom layer 300 is a middle layer 310. The middle layer 310 may be any type of material, such as cloth fabric, plastic, or leather, and may be any size and shape. The middle layer 310 is shaped to have channels to hold the light tubes 210. The middle layer 310 is preferably a translucent material to allow light from the light tubes 210 to pass through. The middle layer 310 may have any number of channels to hold the light tubes 210. The middle layer 310 is attached to the bottom layer 300 in any number of ways. The middle layer 310 may be sewn to the bottom layer 300, glued to the bottom layer 300 or otherwise removably secured or permanently adhered to the bottom layer 300. There is an internal space 302 disposed between the middle layer 310 and bottom layer 300. The internal space 302 provides a space for the wires 220. Disposed on top of the middle layer 310 is a top layer 320. The top layer 320 may be any size and shape and may be made from any type of material, such as cloth fabric, plastic, or leather. The top layer 320 is attached to the middle layer 310 by any means, such as sewn or glued. The top layer 320 may be attached to just a portion of the middle layer 310. There may be sections of the top layer 320. The top layer 320 may be arranged in any configuration. In the preferred embodiment the top layer 320 is disposed centrally on the middle layer 310 to separate the two light tubes 210. There may be multiple top layers 320 disposed on the middle layer 310 to separate multiple light tubes 210.

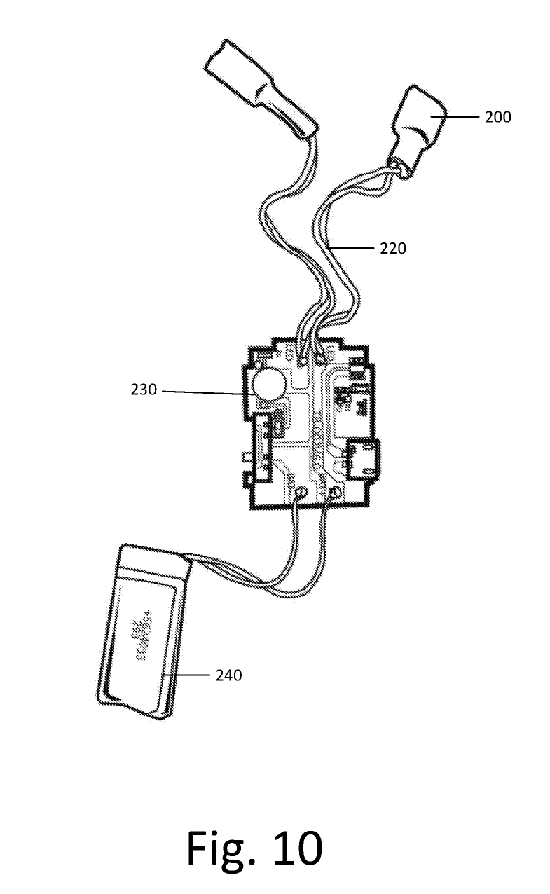

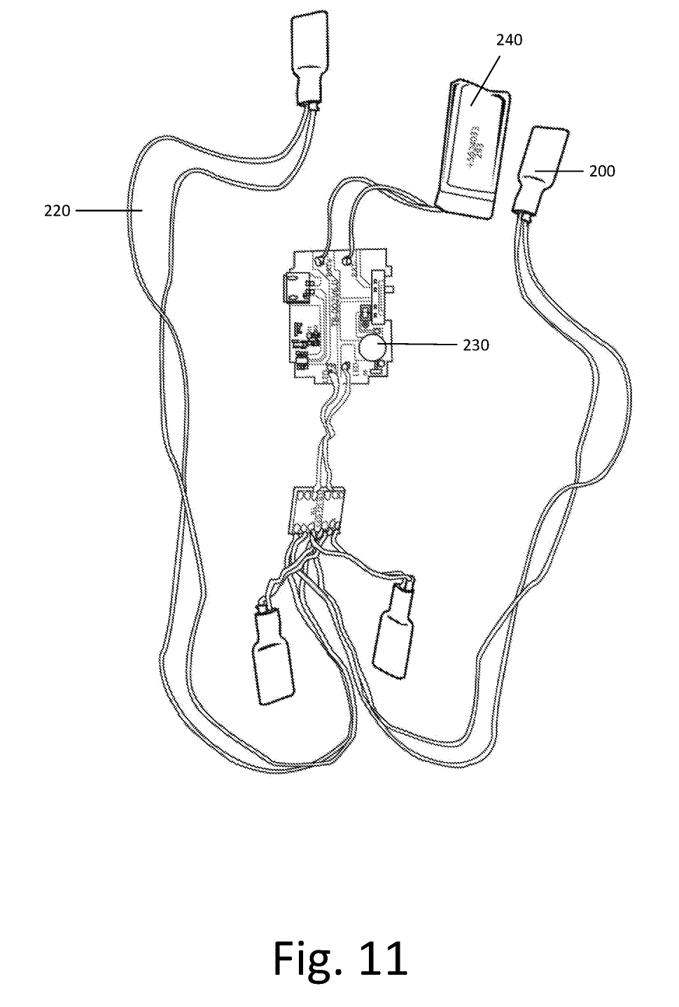

Referring to FIG. 10 and FIG. 11, the electrical components of the light strap 110 are illustrated. The electrical components comprise a microprocessor 230, a battery 240, wires 220, and LEDs 200. The microprocessor 230 is any type of microprocessor unit and is preferably a microcontroller storing program instructions for the operation of the LEDs 200. The microprocessor 230 may also contain one or more sensors to detect data from the environment and adjust the operation of the LEDs 200 accordingly. For instance, in one embodiment the microprocessor 230 has a microphone which detects sound waves. The microprocessor 230 then adjusts the power output to the LEDs 200 depending on the decibel level of the sound received. In this manner the LEDs 200 may illuminate with music or other sound. The sensor may also be a gyroscope or accelerometer or both to detect movement of the user. When the user moves the gyroscope/accelerometer sends signal to the microprocessor 230 and it adjusts the power output to the LEDs 200 accordingly.

The battery pack 240 provides a power source for the electrical components. The battery pack 240 may be any type of battery or batteries. In the preferred embodiment the battery pack 240 is a rechargeable battery. The battery pack 240 and microprocessor 230 are housed in the control pack 120 for protection in the preferred embodiment.

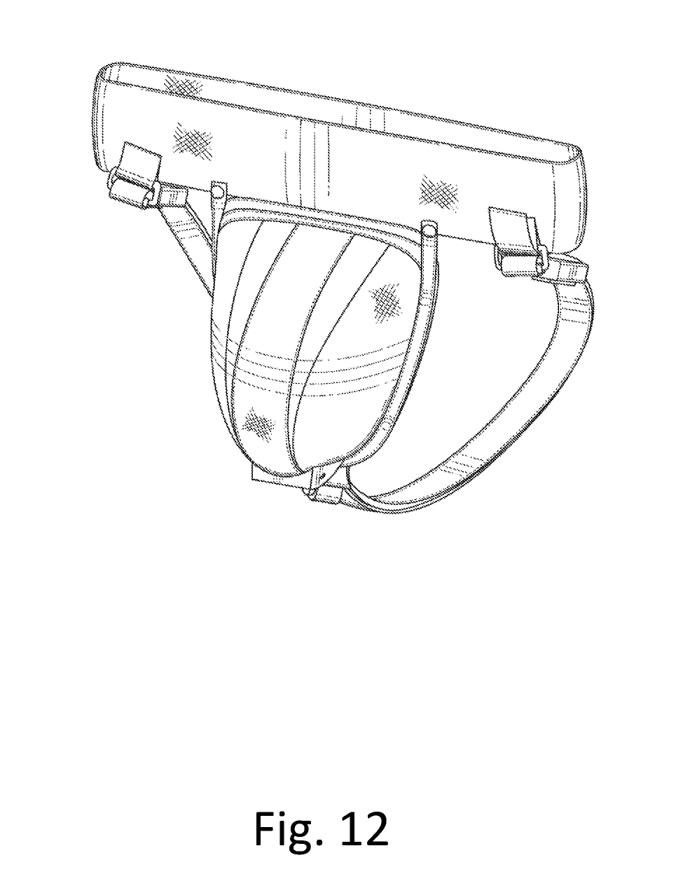

The light emitting clothing 100 may take any form. As illustrated in FIG. 12, the light emitting clothing 100 may be in the form of a jock strap. Other embodiments are possible, such as shoes, slacks, shirts, or any other item of clothing.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) Light illuminating clothing comprising
a) one or more light straps comprising
i) one or more light tubes;
ii) one or more LEDs disposed in said one or more light tubes;
iii) a control pack containing a microprocessor unit and a battery electrically connected to said one or more LEDs;
b) one or more rings;
c) wherein at least one end of said one or more light straps is attached to at least one of said one or more rings.

2) The light illuminating clothing as in claim 1 wherein each of said one or more light straps further comprises
a) a first LED disposed at a first end of said light tube;
b) a second LED disposed at a second end of said light tube; and
c) wherein said light tube comprises a flexible polymeric tube.

3) The light illuminating clothing as in claim 1 further comprising a microphone.

4) The light illuminating clothing as in claim 1 further comprising a motion sensor.

5) The light illuminating clothing as in claim 1 further comprising one or more snaps.

6) The light illuminating clothing as in claim 1 further comprising one or more buckles.

7) The light illuminating clothing as in claim 1 further comprising one or more straps, wherein each of said one or more straps has a first end and a second end, wherein at least said first end of said one or more straps is attached to at least one of said one or more rings.

8) The light illuminating clothing as in claim 1 wherein each of said one or more light straps further comprises
i) a bottom layer of material; and
ii) a middle layer of material disposed on a surface of said bottom layer of material.

9) The light illuminating clothing as in claim 8 wherein said light strap further comprises
a) two light tubes arranged in parallel orientation within two channels in said middle layer of material; and
b) a top layer of material disposed on a surface of said middle layer of material, wherein said top layer of material is disposed in a space between said two light tubes.

10) Light illuminating clothing comprising
a) a first light strap having a first end and a second end and further comprising
i) a buckle disposed at said first end
ii) one or more snaps disposed at said second end
iii) two light tubes disposed in parallel arrangement, each light tube further comprising
(1) a LED;
(2) a flexible polymeric tube;
iv) a control pack electrically connected to said two light tubes and further comprising
(1) a microprocessor unit;
(2) a battery;
b) a second light strap having a first end and a second end and further comprising
i) a buckle disposed at said first end
ii) one or more snaps disposed at said second end
iii) two light tubes disposed in parallel arrangement, each light tube further comprising
(1) a LED;
(2) a flexible polymeric tube;
iv) a control pack electrically connected to said two light tubes and further comprising
(1) a microprocessor unit;
v) a battery;
c) one or more rings; and
d) wherein said first end of said first light strap is attached to a ring;
e) wherein said second end of said first light strap is attached to a ring;
f) wherein said first end of said second light strap is attached to a ring; and
g) wherein said second end of said second light strap is attached to a ring.

11) A light strap for clothing comprising
a) a rectangular material;
b) a control pack secured to said rectangular material;
c) one or more light tubes disposed along at least a length of said rectangular material, said one or more light tubes electrically connected to said control pack;
d) wherein said light strap has a first end and a second end; and
e) wherein said first end of said light strap is attached to a ring.

12) The light strap as in claim 11 further comprising a buckle disposed at said first end of said light strap.

13) The light strap as in claim 11 further comprising one or more snaps disposed at said second end of said light strap.

14) The light strap as in claim 11 wherein said light tube comprises a LED disposed at a first end of a hollow flexible polymeric tube.

15) The light strap as in claim 11 wherein said control pack further comprises a microprocessor unit and a battery.

16) The light strap as in 11 further comprising a middle layer of material attached to a surface of said rectangular material; wherein said middle layer of material comprises one or more channels; wherein said one or more light tubes are respectively disposed within said on or more channels.

17) The light strap as in claim 16 further comprising a top layer of material disposed on a surface of said middle layer of material.

18) The light strap as in claim 17 further comprising two light tubes and wherein said top layer of material is disposed in between said two light tubes.
